(19) United States
(12) Patent Application Publication
(10) Pub. No.: US 2024/0248952 A1
(43) Pub. Date: Jul. 25, 2024

(54) ADAPTIVE ACQUISITION FOR COMPRESSED SENSING

(71) Applicant: QUALCOMM Incorporated, San Diego, CA (US)

(72) Inventors: Gianluigi SILVESTRI, Nijmegen (NL); Fabio Valerio MASSOLI, Amsterdam (NL); Tribhuvanesh OREKONDY, Biel (CH); Arash BEHBOODI, Amsterdam (NL); Joseph Binamira SORIAGA, San Diego, CA (US)

(21) Appl. No.: 18/475,995

(22) Filed: Sep. 27, 2023

Related U.S. Application Data
(60) Provisional application No. 63/481,548, filed on Jan. 25, 2023.

(51) Int. Cl. G06F 17/16

(52) U.S. Cl. CPC G06F 17/16

(57) ABSTRACT

Certain aspects of the present disclosure provide techniques and apparatus for reinforcement-learning-based compressed sensing. An observed signal tensor comprising a plurality of elements is accessed, and a subset of elements of a sensing matrix is generated based on processing, from among the plurality of elements, a subset of elements of the observed signal tensor using an acquisition neural network. A subset of elements of a reconstructed signal tensor is generated based on processing a second subset of elements of the observed signal tensor and the subset of elements of the sensing matrix using a reconstruction neural network. At least the first subset of elements of the reconstructed signal tensor is output.

### CROSS REFERENCE TO RELATED APPLICATION(S)

The present application for patent claims the benefit of priority to U.S. Provisional Appl. No. 63/481,548, filed Jan. 25, 2023, which is hereby incorporated by reference herein in its entirety.

### INTRODUCTION

Aspects of the present disclosure relate to machine learning.

Compressed sensing refers to signal processing techniques used to reconstruct signals in underdetermined linear systems. That is, given an observed signal, compressed sensing may be used to recover or reconstruct the original input signal. Generally, compressed sensing exploits the sparsity of the signal in order to recover the signal using relatively few samples. There are a variety of conventional solutions that attempt to provide efficient and accurate compressed sensing.

However, many conventional approaches to provide compressed sensing suffer from a variety of shortcomings. For example, some conventional solutions rely on discrete measurement spaces (also referred to as action spaces), whereas many realistic measurements are inherently continuous (e.g., angles). As another example, some conventional approaches result in locally optimal solutions (but globally sub-optimal solutions) due to greedy policy gradients. Further, some conventional solutions provide or rely on an initial set of measurements (which can be impractical for common uses) and/or use a fixed reconstruction approach that cannot adequately account for domain shift.

### BRIEF SUMMARY

Certain aspects provide a method comprising: accessing an observed signal tensor comprising a plurality of elements; generating a first subset of elements of a sensing matrix based on processing, from among the plurality of elements, a first subset of elements of the observed signal tensor using an acquisition neural network; generating a first subset of elements of a reconstructed signal tensor based on processing, from among the plurality of elements, a second subset of elements of the observed signal tensor and the first subset of elements of the sensing matrix using a reconstruction neural network; and outputting at least the first subset of elements of the reconstructed signal tensor.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example architecture for reinforcement-learning-based compressed sensing.

FIG. 2 depicts an example architecture for reinforcement-learning-based compressed sensing using an end-to-end reconstruction and acquisition model.

FIG. 3 depicts an example architecture for reinforcement-learning-based compressed sensing using a variational reconstruction and acquisition model.

FIG. 4 is a flow diagram depicting an example method for generating reconstructed signals using reinforcement learning.

FIG. 5 is a flow diagram depicting an example method for training reinforcement learning models to reconstruct signals.

FIG. 6 is a flow diagram depicting an example method for generating reconstructed signal tensors.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved compressed sensing using reinforcement learning.

In some aspects, techniques are provided to recover or reconstruct high-dimensional signals using relatively lower-dimension observations by leveraging the structure of the original high-dimensional signal. By using aspects of the present disclosure, the number of observations used to reconstruct the original signal can be substantially reduced, resulting in reduced computational expense and while producing more accurate reconstructions. In many cases, reducing the number of measurements used can be particularly important when obtaining such measurements is costly or difficult, such as due to resource constraints. As another example, for many medical imaging tasks (e.g., using magnetic resonance imaging (MRI)), utilizing fewer observations to reconstruct the signal can substantially improve the comfort of the patient and reduce the computational and monetary expense of capturing the data.

As discussed below in more detail, in some aspects of the present disclosure, a framework for adaptive sensing with arbitrary sensing operations is provided. In some aspects, the framework can be readily applied for both continuous and discrete spaces (e.g., to reconstruct continuous or discrete signals). In some aspects, the disclosed framework enables end-to-end learning of both reconstruction and acquisition strategies, which combines supervised learning (of the signal to be recovered or reconstructed) with reinforcement learning on latent space for optimal (or at least improved) measurement selection. Further, in some aspects, a probabilistic formulation can be used to augment the machine learning model(s), where the probabilistic formulation and/or models can be trained with a variational lower bound to add structure and probabilistic interpretation to the latent space.

In some aspects of the present disclosure, compressed sensing can be used to recover or reconstruct an input signal x based on an observed signal y and a sensing matrix A. Specifically, in some aspects (e.g., if the architecture uses Gaussian measurements), y=Ax, where A is a sensing matrix of size M×M (where M is the number of acquisitions), y is a tensor of size M×1, and x is a tensor of size N×1. In some aspects, if the input signal x is multidimensional, the system can flatten the input signal to form a column vector of size N×1. In some aspects, when M is significantly smaller than N, the system may be referred to as underdetermined, which may enable efficient use of compressed sensing. In some aspects (e.g., if the architecture uses Radon projections or measurements), the sensing matrix reduces to a vector whose elements correspond to angles in radians.

In some aspects, as discussed in more detail below, the system may use a variety of measurement formats or operations, such as using a Gaussian sensing operation or a radon sensing operation. In some aspects, the Gaussian operation may comprise a matrix multiplication between a random Gaussian matrix A and the flattened image x, where each row of the Gaussian sensing matrix A and of the observed signal y have continuous values between negative infinity and positive infinity. In some such aspects, for a vectorized image (x) of size N×1, the Gaussian sensing matrix A has size T×N, where T is the total number of acquisitions, and y has size 1×N. In the Gaussian implementation, each value in the observations y is scalar.

In some aspects, Gaussian measurements can achieve high accuracy in non-adaptive sensing, while radon measurements may be used to reconstruct medical images such as from CT scans. In the radon implementation, the sensing matrix A may be a vector of size 1×T of angles (in radians), where each element in the sensing matrix has a scalar value between −π and +π. In some aspects, in the radon implementation, if x is an image of size h×w, the resulting observation y is a matrix having dimensions h×T. In some aspects, for the radon implementation, each element of the observations y is a vector of dimensions h×1.

In some aspects of the present disclosure, the compressed sensing problem may be decomposed or understood as two sub-problems: acquiring measurement values (via A), and reconstructing x from y (using A). In aspects of the present disclosure, therefore, adaptive reinforcement-learning-based approaches may be used to acquire measurements (e.g., to generate A element-by-element and/or row-by-row) using a first encoder-decoder pair (which may be referred to as the acquisition neural network or model), and to generate reconstructed input signals (\hat{x}) based on the generated measurement values in A using a second encoder-decoder pair (which may be referred to as the reconstruction neural network or model).

In some aspects, a single shared encoder may be used for both the acquisition model and the reconstruction model. This can enable end-to-end acquisition and reconstruction, improving accuracy and/or reducing the computational expense of training and using the architecture. For example, an encoder subnet may be used to generate a latent tensor, as discussed in more detail below, which is provided to a first decoder subnet for the acquisition model and a second decoder subnet for the reconstruction model. Additionally, in some aspects, a Bayesian formulation may be used to model uncertainty over the signal x and influence the acquisition process. For example, the encoder may generate parameters of a Gaussian distribution, where the acquisition decoder uses these parameters (rather than a single tensor) to generate A. In some such aspects, the distribution may be sampled to generate a latent tensor that is used, by the reconstruction decoder, to generate the reconstructed input signal, as discussed in more detail below.

In some aspects, as discussed in more detail below, the encoder of the acquisition and/or reconstruction models uses a recurrent architecture that maps, at time step t, an action aₜ (e.g., a portion of the sensing matrix A) and a corresponding observation yₜ to a latent representation zₜ based on an encoder hidden state hₜ, where the hidden state summarizes the past actions a_{0:t-1} and observations y_{0:t-1}. This latent representation zₜ can then be processed to generate, for a subsequent iteration or time step (e.g., at time t+1), a next action aₜ₊₁ (e.g., by processing the latent representation using the acquisition model). This process can be similarly repeated for each iteration or time step (e.g., for each measurement or observation) in order to reconstruct the true signal.

Aspects of the present disclosure can provide efficient and accurate compressed sensing for a variety of problems and solutions, depending on the particular implementation. For example, aspects of the present disclosure may be used to provide wireless channel estimation such as in multiple-input multiple-output (MIMO) wireless systems, wireless beam prediction (e.g., in MIMO systems and/or mmWave systems), angle of arrival (AoA) estimation, medical imaging (e.g., for magnetic resonance imaging (MRI)), and in any other underdetermined systems (e.g., for inpainting machine learning models).

### Example Architecture for Reinforcement-Learning-Based Compressed Sensing

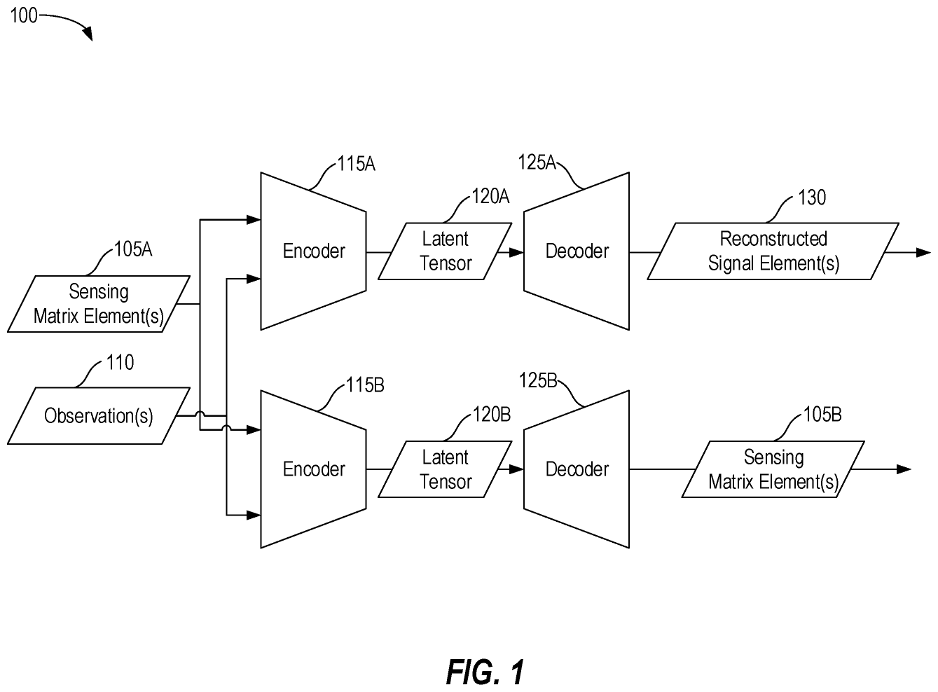

FIG. 1 depicts an example architecture 100 for reinforcement-learning-based compressed sensing. In some aspects, the architecture 100 corresponds to all or a portion of a machine learning system. That is, the architecture 100 may be implemented by a machine learning system (e.g., trained and/or used by the machine learning system) to provide compressed sensing for a variety of solutions, depending on the particular implementation.

In the illustrated architecture, at least a subset of a sensing matrix (e.g., one or more sensing matrix elements 105A) and at least a subset of an observed signal tensor (e.g., set of one or more observations 110) are provided to encoders 115A and 115B in order to generate latent tensors 120A and 120B, respectively. These latent tensors 120A and 120B are then processed by corresponding decoders 125A and 125B to generate a set of one or more reconstructed signal elements 130 and one or more new sensing matrix elements 105B, respectively.

In some aspects, the sensing matrix elements 105A correspond to all or a portion of a sensing matrix A. Similarly, the observations 110 may correspond to all or a portion of an observed signal tensor y. In at least one aspect, the machine learning system uses the architecture to iteratively process subsets of the sensing matrix and observation tensor sequentially for each time step (e.g., for each discrete time). That is, for a first time step t, a first set of sensing matrix elements 105A and a first set of observations 110 that correspond to time t may be used as input to generate reconstructed signal element(s) 130 for time t and a new set of one or more sensing matrix elements 105B for time t+1. For time t+1, this new set of sensing matrix elements 105B may be used, along with a set of observations 110 that correspond to time t+1, to generate the subsequent reconstructed signal elements 130 for time t+1, and so on.

More specifically, for time t, the set of sensing matrix elements 105A may be defined as Aₜ. In at least one aspect, the sensing matrix elements 105A for time t are defined as Aₜ. That is, for time t, the encoders 115A and 115B may process the subset of the sensing matrix that has been generated from time 0 to time t (e.g., the first t rows when incrementing or stepping by 1). Similarly, in some aspects, for time t, the observations 110 may be defined as Yₜ. In at least one aspect, the observations 110 for time t are defined as y_{0:t}. That is, for time t, the encoders 115A and 115B may process the subset of the observed signal tensor that includes elements from time 0 to time t (e.g., the first t elements of the observed tensor when stepping by 1).

Additionally, for time t, the reconstructed signal element(s) 130 may be defined as \hat{x}ₜ, which approximate the ground truth xₜ. The sensing matrix elements 105B generated at time t may be defined as aₜ₊₁. These sensing matrix elements 105B can then be used (along with the sensing matrix elements 105A) as input to the encoders 115A and 115B during the subsequent iteration.

In some aspects, the encoder 115A and decoder 125A may be collectively referred to as a reconstruction neural network or model, while the encoder 115B and decoder 125B may be referred to as an acquisition neural network or model. Further, in some aspects, the encoders 115A and 115B may be referred to as encoder subnets, while decoders 125A and 125B may be referred to as decoder subnets.

In at least one aspect, each encoder 115A and 115B is implemented as a gated recurrent unit (GRU) with one hidden layer and one or more units (e.g., with 128 units). Similarly, in some aspects, the decoder 125A for the reconstruction neural network may be implemented as a two-layer deconvolution network. In at least one aspect, the decoder 125B for the acquisition neural network can be implemented as either a two-layer deconvolution network or a multilayer perceptron (MLP) having one hidden layer with multiple units or nodes (e.g., 256 units).

In some aspects, the decoder 125B directly generates and outputs the sensing matrix elements 105B. In some aspects, however, the decoder 125B can instead be used to generate one or more parameters or values that are then used to generate the sensing matrix elements 105B. Generally, the particular contents and format of the sensing matrix elements 105B and the observations 110 may vary depending on the particular implementation and/or based on the measurement system used.

For example, in some aspects, a Gaussian measurement system is used. In some such aspects, the decoder 125B generates a set of distribution parameters (e.g., a mean and a variance) based on the latent tensor 120B. These distribution parameters may define a Gaussian distribution, which can then be sampled to generate one or more sensing matrix elements 105B. In at least one aspect, the machine learning system samples the distribution to generate a value for each element of a row in the sensing matrix (e.g., the t+1-th row). These newly generated elements can then be used (in conjunction with the previously generated sensing matrix elements, in some aspects) as input for the next time step. In some aspects, when using the Gaussian measurement system, the sensing matrix elements 105B generated at each step may therefore correspond to a row of a matrix, and the sensing matrix elements 105A used as input in a given step may themselves be a matrix (e.g., including each of the previously generated rows). In some such aspects, using a Gaussian measurement approach, the generated reconstructed signal elements 130 may be scalar values. That is, at a given iteration, the decoder 125A may output a single scalar value to be used as the reconstructed signal element 130 for that time step.

As another example, in some aspects, a Radon projection or measurement system is used. In some such aspects, the decoder 125B generates a scalar angle parameter (e.g., a value between −π and π, inclusive) based on the latent tensor 120B. This angle parameter may define a rotation for a radon transformation/operation. In some aspects, the angle parameter determines the sensing matrix element(s) 105B. That is, the newly generated angle parameter can then be used (in conjunction with the previously generated sensing matrix elements, in some aspects) as input for the next time step. Stated differently, at each time step, the decoder 125B may output a single scalar value (in radians) which can be used as the sensing matrix element 105B (e.g., a single element rather than a row of elements). Similarly, the input sensing matrix elements 105A at each time step may be the sequence of (scalar) values, each generated during a previous iteration (e.g., a vector of scalar values in radians). In some such aspects, using the radon measurement approach, the generated reconstructed signal elements 130 may be vector values. That is, at a given iteration, the decoder 125A may output a vector of scalar values (e.g., 28 values) to be used as the reconstructed signal elements 130 for that time step.

In some aspects, during inferencing (e.g., after the architecture 100 has been trained by the machine learning system or by another system), the machine learning system can sequentially generate reconstructed signal elements 130 and additional sensing matrix elements 105B until each of the observations 110 for a given sample have been processed. These reconstructed signal elements 130 and/or sensing matrix elements 105B may then be output or returned as the output of the architecture 100 (e.g., returned to a requesting entity that provided the input observations 110).

In some aspects, during the first iteration (e.g., for the first observation 110 at t=0), no sensing matrix elements 105A may be available (e.g., because there is no prior iteration during which such elements could be generated). In some aspects, therefore, the machine learning system can use a defined value for this first time step (e.g., a value of zero) or may use a randomly generated value.

In some aspects, to train the architecture 100, the machine learning system may evaluate a ground-truth input signal associated with the observed output signal (e.g., the observations 110). That is, a given observed signal tensor y may have a corresponding ground-truth input signal tensor x.

In some aspects, the reconstruction neural network (e.g., the decoder 125A and the encoder 115A) can be refined based on the error (e.g., the mean squared error (MSE)) of the generated reconstructed signal elements 130 (e.g., \hat{x}) as compared to the ground-truth x. In at least one aspect, the machine learning system computes the MSE for each time step in the reconstruction. That is, the machine learning system can compute the MSE between x_{0:t} and \hat{x}_{0:t} for each time step from 0 to t. In some one aspects, these MSEs for each time step can then be aggregated (e.g., by summing the errors) to generate a reconstruction loss for the reconstruction network. This loss may then be used to generate gradients and refine the reconstruction network, such as by using backpropagation through the decoder 125A and then through the encoder 115A in order to refine or update the parameters (e.g., weights) of each. Generally, this can be accomplished independently based on each individual sample (e.g., using stochastic gradient descent) or based on batches of training samples (e.g., using batch gradient descent).

In some aspects, the acquisition neural network (e.g., the decoder 125B and the encoder 115B) can be refined based on the structural similarity (e.g., by generating a structural similarity index measure (SSIM)) of the generated reconstructed signal elements 130 (e.g., \hat{x}) with the ground-truth x. In at least one aspect, the machine learning system computes the SSIM for each time step in the reconstruction. That is, the machine learning system may compute the SSIM between x_{0:t} and \hat{x}_{0:t} for each time step between 0 and t. In some aspects, at each discrete time t, the SSIM value for the prior time t−1 can be subtracted from the SSIM value for the current time (e.g., the machine learning system may compute SSIMₜ(x_{0:t}, \hat{x}_{0:t})−SSIMₜ₋₁(x_{0:t-1}, \hat{x}_{0:t-1}) to generate an acquisition loss (also referred to in some aspects as the reward), where the acquisition network is refined to attempt to maximize this value (e.g., because larger values indicate that the current reconstruction for time t is better than the prior reconstruction at time−1). In this way, this acquisition loss may be used to generate gradients and refine the acquisition network, such as by using backpropagation through the decoder 125B and then through the encoder 115B in order to refine or update the parameters (e.g., weights) of each. Generally, this can be accomplished independently based on each individual sample (e.g., using stochastic gradient descent) or based on batches of training samples (e.g., using batch gradient descent). In some aspects, during the first iteration at t=0 (e.g., where there is no reconstructed signal element 130 and/or ground truth signal element for t−1), the loss may be simply SSIM₀(x₀, \hat{x}₀).

In some aspects, this SSIM-based approach may be referred to as a “vanilla” policy gradient. In some aspects, the machine learning system may additionally or alternatively use one or more trust region approaches (e.g., trust region policy optimization (TRPO) and/or proximal policy optimization (PPO)) to generate gradients and refine the acquisition network.

### Example Architecture for Reinforcement-Learning-Based Compressed Sensing Using an End-To-End Reconstruction and Acquisition Model

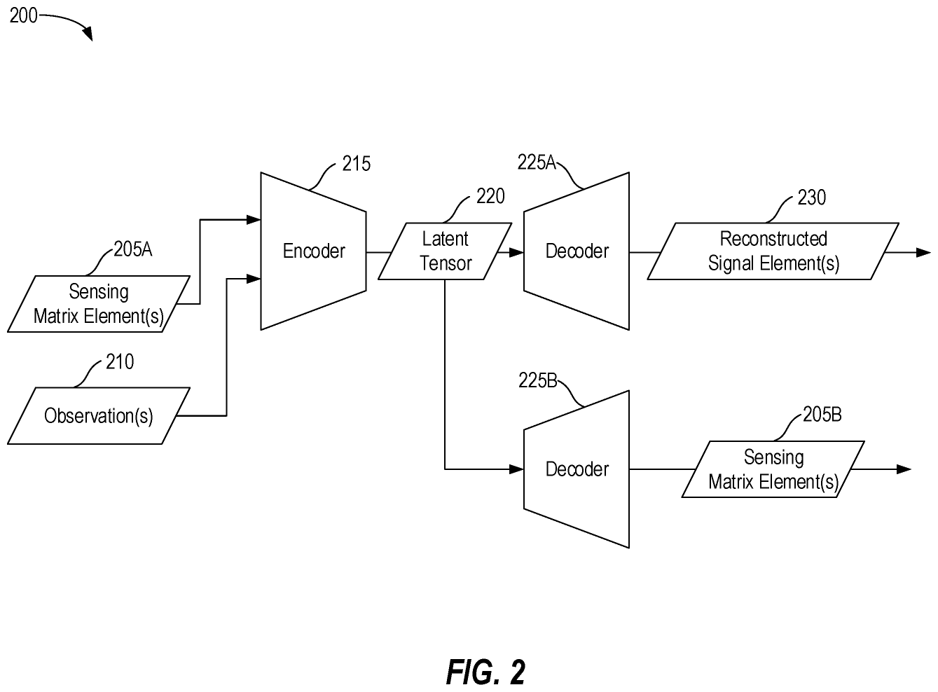

FIG. 2 depicts an example architecture 200 for reinforcement-learning-based compressed sensing using an end-to-end reconstruction and acquisition model. In some aspects, the architecture 200 corresponds to all or a portion of a machine learning system. That is, the architecture 200 may be implemented by a machine learning system (e.g., trained and/or used by the machine learning system) to provide compressed sensing for a variety of solutions, depending on the particular implementation.

In the illustrated example, the reconstruction network and the acquisition network utilize a shared encoder 215, rather than independent encoders. Specifically, in the illustrated architecture 200, at least a subset of a sensing matrix (e.g., one or more sensing matrix elements 205A) and at least a subset of an observed signal tensor (e.g., set of one or more observations 210) are provided to the shared encoder 215 in order to generate a single latent tensor 220. This latent tensor 220 is then processed by corresponding decoders 225A and 225B to generate a set of one or more reconstructed signal elements 230 and one or more new sensing matrix elements 205B, respectively. Generally, in the illustrated architecture, the sensing matrix elements 205A may correspond to the sensing matrix elements 105A, the observations 210 may correspond to the observations 110, the encoder 215 may correspond to both the encoders 115A and 115B, the decoders 225A and 225B may correspond to the decoders 125A and 125B, the reconstructed signal elements 230 may correspond to the reconstructed signal elements 130, and the sensing matrix elements 205B may correspond to the sensing matrix elements 105B, each of FIG. 1.

In some aspects, as discussed above, the sensing matrix elements 205A correspond to all or a portion of a sensing matrix A, and the observations 210 correspond to all or a portion of an observed signal tensor y. In at least one aspect, as discussed above, the machine learning system uses the architecture to iteratively process subsets of the sensing matrix and observation tensor sequentially for each time step. That is, for a first time t, a first set of sensing matrix elements 205A and a first set of observations 210 that correspond to time t may be used as input to generate reconstructed signal element(s) 230 for time t and a new set of one or more sensing matrix elements 205B for time t+1. For time t+1, this new set of sensing matrix elements 205B may be used, along with a set of observations 210 that correspond to time t+1, to generate the subsequent reconstructed signal elements 230 for time t+1, and so on.

More specifically, for time t, the corresponding set of sensing matrix elements 205A may be defined as Aₜ. In at least one aspect, the sensing matrix elements 205A for time t are defined as a_{0:t}. That is, for time t, the encoder 215 may process the subset of the sensing matrix that has been generated from time 0 to time t (e.g., the first t rows when stepping by 1). Similarly, in some aspects, for time t, the observations 210 may be defined as Yₜ. In at least one aspect, the observations 210 for time t are defined as y_{0:t}. That is, for time t, the encoder 215 may process the subset of the observed signal tensor that includes elements from time 0 to time t (e.g., the first t elements of the observed tensor when stepping by 1).

Additionally, for time t, the reconstructed signal element(s) 230 may be defined as \hat{x}ₜ, which approximate the ground truth xₜ. The sensing matrix elements 205B generated at time t may be defined as aₜ₊₁.

In some aspects, the shared encoder 215, the decoder 225A, and the decoder 225B may be collectively referred to as an end-to-end reconstruction and acquisition network or model. Further, in some aspects, the encoder 215 may be referred to as a shared encoder subnet, while decoders 225A and 225B may be referred to as decoder subnets.

In at least one aspect, the encoder 215 is implemented as a gated recurrent unit (GRU) with one hidden layer and one or more units (e.g., with 128 units). Similarly, in some aspects, the decoder 225A for the reconstruction network may be implemented as a two-layer deconvolution network. In at least one aspect, the decoder 225B for the acquisition network can be implemented as either a two-layer deconvolution network or a multilayer perceptron (MLP) having one hidden layer with multiple units or nodes (e.g., 256 units).

In some aspects, the decoder 225B directly generates and outputs the sensing matrix elements 205B. In other aspects, as discussed above, the decoder 225B can instead be used to generate one or more parameters or values that are then used to generate the sensing matrix elements 205B. For example, as discussed above, a Gaussian measurement system may be used (e.g., where the decoder 225B generates a set of distribution parameters that can be sampled to generate one or more sensing matrix elements 205B). As another example, as discussed above, a radon measurement system may be used (e.g., where the decoder 225B generates an angle parameter).

In some aspects, during inferencing (e.g., after the architecture 200 has been trained by the machine learning system or by another system), the machine learning system can sequentially generate reconstructed signal elements 230 and additional sensing matrix elements 205B, as discussed above, until each of the observations 210 for a given sample have been processed. These reconstructed signal elements 230 and/or sensing matrix elements 205B may then be output or returned as the output of the architecture 200 (e.g., returned to a requesting entity that provided the input observations 210).

In some aspects, during the first iteration (e.g., for the first observation 210 at t=0), no sensing matrix elements 205A may be available (e.g., because there is no prior iteration during which such elements could be generated). In some aspects, therefore, the machine learning system can use a defined value for this first time step (e.g., a value of zero) or may use a randomly generated value.

In some aspects, to train the architecture 200, the machine learning system may evaluate a ground-truth input signal tensor associated with the observed output signal tensor (e.g., the observations 210), as discussed above. That is, a given observed signal y may have a corresponding ground-truth input signal x.

In some aspects, the reconstruction network (e.g., the decoder 225A and the encoder 215) can be refined based on the error (e.g., the mean squared error (MSE)) of the generated reconstructed signal elements 230 (e.g., \hat{x}) as compared to the ground-truth x, as discussed above. In at least one aspect, the machine learning system computes the MSE for each time step in the reconstruction. That is, the machine learning system can compute the MSE between x_{0:t} and \hat{x}_{0:t} for each time step from 0 to t. In some aspects, these MSEs for each time step can then be aggregated (e.g., by summing the errors) to generate a reconstruction loss for the reconstruction network. This loss may then be used to generate gradients and refine the reconstruction network, such as by using backpropagation through the decoder 225A and then through the encoder 215 in order to refine or update the parameters (e.g., weights) of each. That is, the machine learning system may propagate gradients through the decoder 225A and encoder 215 end-to-end to refine both. Generally, this can be accomplished independently based on each individual sample (e.g., using stochastic gradient descent) or based on batches of training samples (e.g., using batch gradient descent).

In some aspects, the acquisition network (e.g., the decoder 225B) can be refined based on the structural similarity (e.g., by generating a structural similarity index measure (SSIM)) of the generated reconstructed signal elements 230 (e.g., \hat{x}) with the ground-truth x. In at least one aspect, the machine learning system computes the SSIM for each time step in the reconstruction. That is, the machine learning system may compute the SSIM between x_{0:t} and \hat{x}_{0:t} for each time t. In some aspects, at each time t, the SSIM value for the prior time t−1 can be subtracted from the SSIM value for the current time (e.g., the machine learning system may compute SSIMₜ(x_{0:t}, \hat{x}_{0:t})−SSIMₜ₋₁(x_{0:t-1}, \hat{x}_{0:t-1}) to generate an acquisition loss (also referred to in some aspects as the reward), where the acquisition network is refined to attempt to maximize this value (e.g., because larger values indicate that the current reconstruction for time t is better than the prior reconstruction at time t−1). In this way, this acquisition loss may be used to generate gradients and refine the acquisition network, such as by using backpropagation through the decoder 225B in order to refine or update the parameters (e.g., weights) of the decoder 225B. Generally, this can be accomplished independently based on each individual sample (e.g., using stochastic gradient descent) or based on batches of training samples (e.g., using batch gradient descent). Notably, in some aspects, no gradients flow from the decoder 225B to the encoder 215. That is, the encoder 215 is refined based on gradients generated for the reconstruction network and propagated through the decoder 225A, and is not updated or changed by the gradients propagated through the decoder 225B.

### Example Architecture for Reinforcement-Learning-Based Compressed Sensing Using a Variational Reconstruction and Acquisition Model

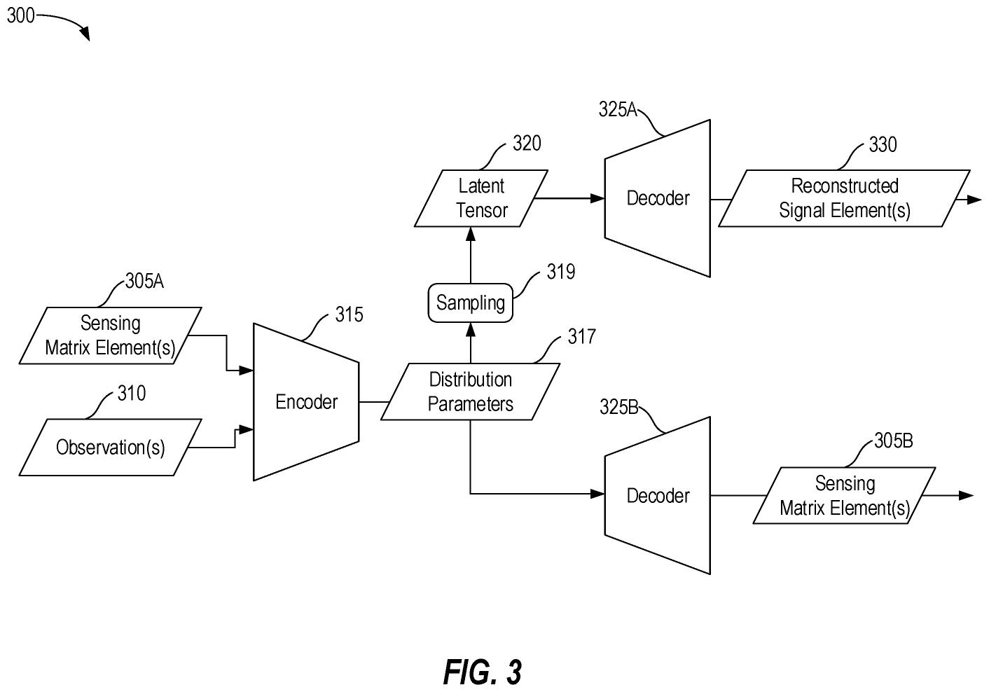

FIG. 3 depicts an example architecture 300 for reinforcement-learning-based compressed sensing using a variational reconstruction and acquisition model. In some aspects, the architecture 300 corresponds to all or a portion of a machine learning system. That is, the architecture 300 may be implemented by a machine learning system (e.g., trained and/or used by the machine learning system) to provide compressed sensing for a variety of solutions, depending on the particular implementation.

Generally, in the illustrated architecture 300, the sensing matrix elements 305A may correspond to the sensing matrix elements 205A, the observations 310 may correspond to the observations 210, the encoder 315 may correspond to the encoder 215, the decoders 325A and 325B may correspond to the decoders 225A and 225B, the reconstructed signal elements 330 may correspond to the reconstructed signal elements 230, and the sensing matrix elements 305B may correspond to the sensing matrix elements 205B, each of FIG. 2.

In the illustrated example, the reconstruction network and the acquisition network utilize a shared encoder 315, as discussed above. Specifically, in the illustrated architecture 300, at least a subset of a sensing matrix (e.g., one or more sensing matrix elements 305A) and at least a subset of an observed signal tensor (e.g., set of one or more observations 310) are provided to the shared encoder 315 in order to generate a set of distribution parameters 317. That is, rather than generating a latent tensor, the encoder 315 generates distribution parameters 317 (e.g., a mean and a variance of a Gaussian distribution). In the illustrated example, these distribution parameters 317 are then provided as input to the decoder 325B. In this way, the acquisition network uses a variational approach.

In the illustrated example, the distribution parameters 317 are also sampled (as indicated by sampling block 319) to generate a latent tensor 320. That is, the latent tensor 320 may be generated by sampling the distribution defined by the distribution parameters 317. This latent tensor 320 is then processed by the decoder 325A to generate a set of one or more reconstructed signal elements 330. In some aspects, the shared encoder 315, the decoder 325A, and the decoder 325B may be collectively referred to as an end-to-end variational reconstruction and acquisition network or model.

In at least one aspect, the encoder 315 is implemented as a gated recurrent unit (GRU) with one hidden layer and one or more units (e.g., with 128 units). Similarly, in some aspects, the decoder 325A for the reconstruction network may be implemented as a two-layer deconvolution network. In at least one aspect, the decoder 325B for the acquisition network can be implemented as either a two-layer deconvolution network or a multilayer perceptron (MLP) having one hidden layer with multiple units or nodes (e.g., 256 units).

In some aspects, the decoder 325B directly generates and outputs the sensing matrix elements 305B. In other aspects, as discussed above, the decoder 325B can instead be used to generate one or more parameters or values that are then used to generate the sensing matrix elements 305B. For example, as discussed above, a Gaussian measurement system may be used, or a radon measurement system may be used.

In some aspects, during inferencing (e.g., after the architecture 300 has been trained by the machine learning system or by another system), the machine learning system can sequentially generate reconstructed signal elements 330 and additional sensing matrix elements 305B, as discussed above, until each of the observations 310 for a given sample have been processed. These reconstructed signal elements 330 and/or sensing matrix elements 305B may then be output or returned as the output of the architecture 300 (e.g., returned to a requesting entity that provided the input observations 310).

In some aspects, during the first iteration (e.g., for the first observation 310 at t=0), no sensing matrix elements 305A may be available (e.g., because there is no prior iteration during which such elements could be generated). In some aspects, therefore, the machine learning system can use a defined value for this first time step (e.g., a value of zero) or may use a randomly generated value.

In some aspects, to train the architecture 300, the machine learning system may evaluate a ground-truth input signal associated with the observed output signal (e.g., the observations 310), as discussed above. For example, to refine the decoder 325A and encoder 315 (e.g., based on the MSE between the reconstructed signal elements 330 and ground-truth signal). Similarly, to refine the decoder 325B, the machine learning system may compute the SSIM at each time step.

### Example Method for Generating Reconstructed Signals Using Reinforcement Learning

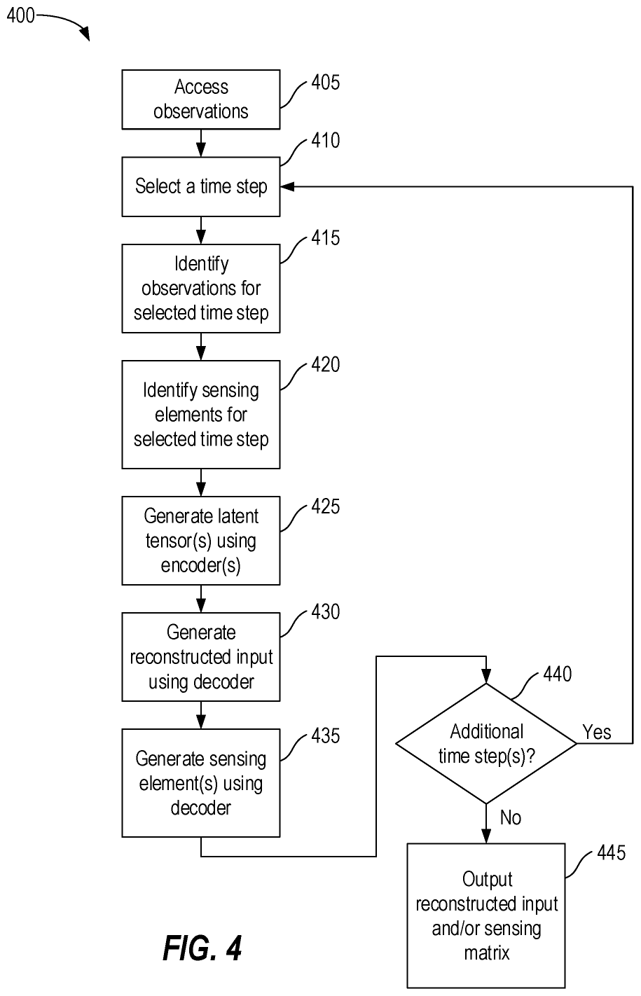

FIG. 4 is a flow diagram depicting an example method 400 for generating reconstructed signals using reinforcement learning. In some aspects, the method 400 is performed by a system, such as the machine learning system that corresponds to, includes, and/or implements architectures 100, 200, and/or 300 of FIGS. 1, 2, and/or 3.

At block 405, the machine learning system accesses an observed signal tensor (also referred to as a set of observations). For example, the machine learning system may access an observed signal tensor y, such as including the observations 110 of FIG. 1, the observations 210 of FIG. 2, and/or the observations 310 of FIG. 3. As discussed above, the observed signal tensor generally corresponds to the resulting or observed output signal based on an input signal that has been modified or transformed. For example, in a wireless communication setting, the input signal x may correspond to the originally transmitted signal, and the observed signal y may correspond to the measured or received signal (which may be modified or transformed in the wireless medium during transit).

Generally, accessing data may include receiving, retrieving, requesting, or otherwise gaining access to the data. For example, at block 405, the machine learning system may receive the observations from one or more other devices or systems (or from one or more components or applications of the machine learning system itself), from a user, and the like.

At block 410, the machine learning system selects a time step reflected in the observations. As discussed above, the observations may generally comprise a set or sequence of elements, each element having an observed value, where each element corresponds to a particular time step from time t=0 to time t=T (where there are T∓1 elements in the observed signal tensor when stepping by t=1). Generally, the number of elements in the sequence may be a hyperparameter of the system, and/or may be determined based on the time steps reflected in the input observations.

In some aspects, at block 410, the machine learning system selects the time steps in sequential order. That is, the machine learning system may first select the first time step (e.g., t=0), followed by the second, and so on until each time step has been processed.

At block 415, the machine learning system identifies one or more observations, in the accessed observed signal tensor, that correspond to the selected time step (e.g., the observations 110 of FIG. 1, observations 210 of FIG. 2, and/or observations 310 of FIG. 3). For example, for time step t, the machine learning system may identify yₜ. In some aspects, as discussed above, for a given time step (e.g., a discrete time), the machine learning system may select the observation for the selected time step as well as the previous time steps. For example, for time step t, the machine learning system may identify y_{0:t}.

At block 420, the machine learning system then identifies zero or more sensing matrix elements that correspond to the selected time step (e.g., the sensing matrix elements 105A of FIG. 1, sensing matrix elements 205A of FIG. 2, and/or sensing matrix elements 305A of FIG. 3). For example, for time step t, the machine learning system may identify aₜ. In some aspects, as discussed above, for a given time step, the machine learning system may select the sensing matrix elements for the selected time step as well as the previous time steps. For example, for time step t, the machine learning system may identify a_{0:t}. In at least one aspect, during the first iteration (e.g., for the first time step at t=0), there may be no generated sensing matrix elements available, and the machine learning system may therefore use a value of zero, or may use another value (such as a randomly generated value).

At block 425, the machine learning system generates one or more latent tensors (e.g., the latent tensors 120A and/or 120B of FIG. 1, latent tensor 220 of FIG. 2, and/or latent tensor 320 of FIG. 3) using one or more encoders (e.g., the encoders 115A and/or 115B of FIG. 1, encoder 215 of FIG. 2, and/or encoder 315 of FIG. 3), as discussed above. For example, the machine learning system may process the set of observations (identified at block 415) and the set of measurements (identified at block 420) for the current time step (selected at block 410) to generate one or more corresponding latent tensors for the current time step.

In some aspects, as discussed above, the encoder generates the latent tensor(s) directly. In some aspects, the encoder generates a set of distribution parameters which define a distribution that can then be sampled to generate the latent tensor, as discussed above.

At block 430, the machine learning system generates one or more reconstructed input elements (e.g., the reconstructed signal element(s) 130 of FIG. 1, reconstructed signal element(s) 230 of FIG. 2, and/or reconstructed signal element(s) 330 of FIG. 3) using a reconstruction decoder subnet (e.g., the decoder 125A of FIG. 1, decoder 225A of FIG. 2, and/or decoder 325A of FIG. 3). For example, as discussed above, the machine learning system may process the generated latent tensor (generated using the shared encoder and/or using the reconstruction-specific encoder) using the reconstruction decoder subnet. In some aspects, as discussed above, the reconstructed input signal element(s) generated for time step t may be defined as \hat{x}ₜ.

At block 435, the machine learning system generates one or more sensing matrix elements (e.g., the sensing matrix element(s) 105B of FIG. 1, sensing matrix element(s) 205B of FIG. 2, and/or sensing matrix element(s) 305B of FIG. 3) using an acquisition decoder subnet (e.g., the decoder 125B of FIG. 1, decoder 225B of FIG. 2, and/or decoder 325B of FIG. 3). For example, as discussed above, the machine learning system may process the generated latent tensor (generated using the shared encoder and/or using the acquisition-specific encoder) using the acquisition decoder subnet, or may process distribution parameters (generated using the shared encoder and/or the acquisition-specific encoder) using the acquisition decoder subnet. In some aspects, as discussed above, the sensing matrix element(s) generated for time step t may be defined as aₜ₊₁.

In at least one aspect, if the current time step (selected at block 410) is the final time step in the observations, then the machine learning system may forgo generation of the next set of sensing matrix element(s) at block 435 in order to reduce computational expense of the method 400.

At block 440, the machine learning system determines whether there is at least one additional time step remaining in the sequence of observations. If so, then the method 400 returns to block 410 to select the next time step in the sequence. In this way, the machine learning system can iteratively and adaptively generate new sensing matrix elements and reconstructed signal elements until each of the time steps have been processed.

If, at block 440, the machine learning system determines that no additional time steps remain, the method 400 continues to block 445, where the machine learning system outputs the reconstructed input (e.g., the concatenation or aggregation of the values of \hat{x}ₜ generated at each time step) and/or the generated sensing matrix (e.g., the concatenation or aggregation of the values of aₜ₊₁ generated at each time step).

### Example Method for Training Reinforcement Learning Models to Reconstruct Signals

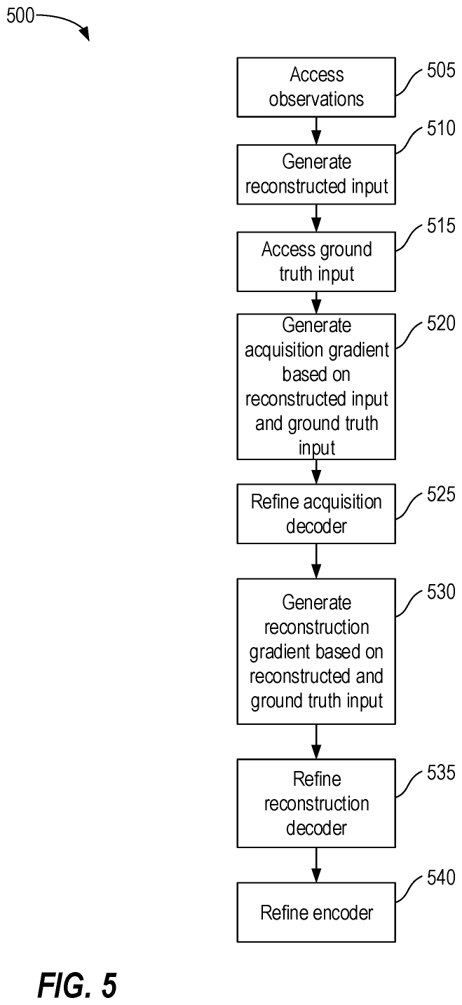

FIG. 5 is a flow diagram depicting an example method 500 for training reinforcement learning models to reconstruct signals. In some aspects, the method 500 is performed by a system, such as the machine learning system that corresponds to, includes, and/or implements architectures 100, 200, and/or 300 of FIGS. 1, 2, and/or 3. In some aspects, the system that performs the method 500 (to train the models) is the same system that performs method 400 of FIG. 4 (to inference using trained models). In other aspects, the training system (that performs the method 500) may be different than the system that performs method 400 of FIG. 4 (to inference using trained models). That is, training and inferencing may be performed by a single system, or a first system may inference using models trained by one or more other systems.

At block 505, the machine learning system accesses an observed signal tensor (also referred to as a set of observations) for training. For example, the machine learning system may access an observed signal tensor y, which may correspond to observations 110 of FIG. 1, the observations 210 of FIG. 2, and/or the observations 310 of FIG. 3. As discussed above, the observed signal tensor generally corresponds to the resulting output signal based on an input signal that has been modified or transformed. For example, in a wireless communication setting, the input signal x may correspond to the originally transmitted signal, and the observed signal y may correspond to the measured or received signal (which may be modified or transformed in the wireless medium during transit).

At block 510, the machine learning system generates reconstructed input based on processing the observations using reconstruction and/or acquisition network(s), as discussed above (e.g., as described with reference to blocks 410, 415, 420, 425, 430, 435, and 440 of FIG. 4). For example, at each time step (e.g., each discrete time), the corresponding observations and sensing matrix elements may be processed by one or more encoders to generate one or more distribution parameters and/or latent tensors, which may then be processed by one or more decoders to generate the reconstructed input for the time step (as well as a new sensing matrix element for the next time step).

At block 515, the machine learning system accesses a ground truth input signal that corresponds to the observations accessed at block 505. That is, during training, the sequence of observations in the observed signal tensor may have a corresponding sequence of actual input signals in an input signal tensor, where the observed output was created/observed based on the (potentially transformed) ground truth input.

At block 520, the machine learning system generates one or more acquisition gradients based on the reconstructed input (generated at block 510) and the ground truth input (accessed at block 515). In some aspects, as discussed above, the acquisition gradients are generated based on the structural similarity (e.g., the SSIM) of the generated reconstructed signal elements (e.g., \hat{x}) and the ground-truth (e.g., x). In at least one aspect, the machine learning system computes an SSIM for each time step in the reconstruction. That is, the machine learning system may compute the SSIM between x_{0:t} and \hat{x}_{0:t} for each time step t. In some aspects, at each time step t, the SSIM value for the prior time step t−1 can be subtracted from the SSIM value for the current time step (e.g., the machine learning system may compute SSIMₜ(x_{0:t}, \hat{x}_{0:t})−SSIMₜ₋₁(x_{0:t-1}, \hat{x}_{0:t-1}) to generate an acquisition loss (also referred to in some aspects as the reward), where the acquisition network is refined to attempt to maximize this value (e.g., because larger values indicate that the current reconstruction for time t is better than the prior reconstruction at time step t−1). In some aspects, during the first iteration at t=0 (e.g., where there is no reconstructed signal element and/or ground truth signal element for t−1), the loss may be simply SSIM₀(x₀, \hat{x}₀). In some aspects, the acquisition loss is generated by summing the individual reward values (e.g., Σᵢ₌₀^{t}SSIMₜ(x_{0:t}, \hat{x}_{0:t})−SSIMₜ₋₁(x_{0:t-1}, \hat{x}_{0:t-1}) for all time steps t). In this way, the model parameters are updated to maximize the sum of the rewards for each time step.

In some aspects, the machine learning system may additionally or alternatively use one or more trust region approaches (e.g., trust region policy optimization (TRPO) and/or proximal policy optimization (PPO)) to generate gradients and refine the acquisition network.

At block 525, the machine learning system refines the acquisition decoder (e.g., updating one or more parameters of the decoder, such as the decoder 125B of FIG. 1, the decoder 225B of FIG. 2, and/or the decoder 325B of FIG. 3) based on the generated acquisition gradient(s), such as using backpropagation. Generally, this can be accomplished independently based on each individual sample (e.g., using stochastic gradient descent) or based on batches of training samples (e.g., using batch gradient descent). Although not included in the illustrated example, in some aspects, the machine learning system may further refine an encoder for the acquisition network (e.g., the encoder 115B of FIG. 1) based on the acquisition gradients.

At block 530, the machine learning system generates one or more reconstruction gradients based on the reconstructed input (generated at block 510) and the ground truth input (accessed at block 515). In some aspects, as discussed above, the reconstruction gradients are generated based on the error (e.g., the mean squared error (MSE)) of the generated reconstructed signal elements (e.g., \hat{x}) as compared to the ground-truth (e.g., x). In at least one aspect, the machine learning system computes the MSE for each time step in the reconstruction. That is, the machine learning system can compute the MSE between x_{0:t} and \hat{x}_{0:t} for each time step from 0 to t. In some aspects, these MSEs for each time step can then be aggregated (e.g., by summing the errors) to generate the overall reconstruction loss/gradients for the reconstruction network.

At block 535, the machine learning system refines the reconstruction decoder (e.g., updating one or more parameters of the decoder, such as the decoder 125A of FIG. 1, the decoder 225A of FIG. 2, and/or the decoder 325A of FIG. 3) based on the generated reconstruction gradient(s), such as using backpropagation. Generally, this can be accomplished independently based on each individual sample (e.g., using stochastic gradient descent) or based on batches of training samples (e.g., using batch gradient descent).

Further, at block 540, the machine learning system refines the reconstruction encoder (e.g., updating one or more parameters of the encoder, such as the encoder 115A of FIG. 1, the encoder 215 of FIG. 2, and/or the encoder 315 of FIG. 3) based on the generated reconstruction gradient(s), such as using backpropagation through the reconstruction decoder and the encoder. Generally, this can be accomplished independently based on each individual sample (e.g., using stochastic gradient descent) or based on batches of training samples (e.g., using batch gradient descent). In some aspects, as discussed above, the reconstruction encoder may be a shared encoder that is used by both the reconstruction decoder and the acquisition decoder (though, during training, the reconstruction gradients may flow through the reconstruction decoder and not through the acquisition decoder).

In this way, using the method 500, the machine learning system can update the parameters of the encoder(s) and decoders based on training samples. The method 500 may generally be performed any number of times for any number of samples. Further, as discussed above, although the illustrated example suggests refining the networks for a single sample, in some aspects, the system may evaluate a batch of samples to generate an aggregate loss or gradients, and refine the models using these aggregated values (e.g., using batch gradient descent).

### Example Method for Generating Reconstructed Signal Tensors

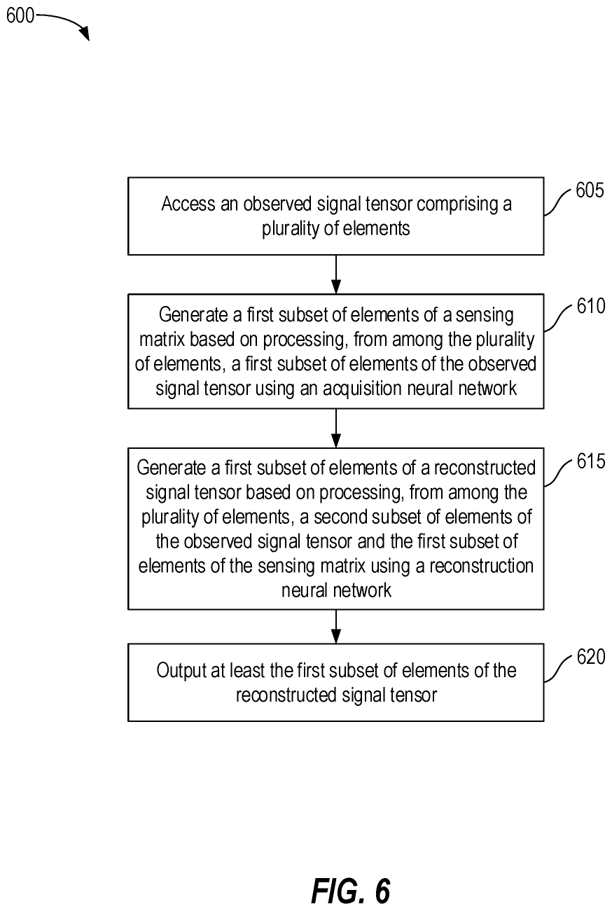

FIG. 6 is a flow diagram depicting an example method 600 for generating reconstructed signal tensors. In some aspects, the method 600 is performed by a system, such as the machine learning system that corresponds to, includes, and/or implements architectures 100, 200, and/or 300 of FIGS. 1, 2, and/or 3.

At block 605, an observed signal tensor comprising a plurality of elements is accessed.

At block 610, a first subset of elements of a sensing matrix is generated based on processing, from among the plurality of elements, a first subset of elements of the observed signal tensor using an acquisition neural network.

In some aspects, generating the first subset of elements of the sensing matrix comprises: generating a set of distribution parameters by processing the first subset of elements of the observed signal tensor using the acquisition neural network, and sampling a distribution, defined by the set of distribution parameters, to generate the first subset of elements of the sensing matrix.

In some aspects, generating the first subset of elements of the sensing matrix comprises generating an angle parameter by processing the first subset of elements of the observed signal tensor using the acquisition neural network.

At block 615, a first subset of elements of a reconstructed signal tensor is generated based on processing, from among the plurality of elements, a second subset of elements of the observed signal tensor and the first subset of elements of the sensing matrix using a reconstruction neural network.

In some aspects, the acquisition neural network comprises a first encoder subnet and a first decoder subnet, and the reconstruction neural network comprises a second encoder subnet and a second decoder subnet.

In some aspects, the first encoder subnet and the second encoder subnet form a shared encoder subnet.

In some aspects, the first subset of elements of the observed signal tensor and the second subset of elements of the observed signal tensor differ by at least one element.

In some aspects, generating the first subset of elements of the reconstructed signal tensor comprises: generating a latent tensor based on processing the second subset of elements of the observed signal tensor and the first subset of elements of the sensing matrix using the shared encoder subnet, and generating the first subset of elements of the reconstructed signal tensor based on processing the latent tensor using the second decoder subnet.

In some aspects, generating the second subset of elements of the sensing matrix comprises processing the latent tensor using the first decoder subnet.

In some aspects, generating the first subset of elements of the reconstructed signal tensor comprises: generating a set of distribution parameters based on processing the second subset of elements of the observed signal tensor and the first subset of elements of the sensing matrix using the shared encoder subnet, sampling a distribution, defined by the set of distribution parameters, to generate a latent tensor, and generating the first subset of elements of the reconstructed signal tensor based on processing the latent tensor using the second decoder subnet.

In some aspects, generating the second subset of elements of the sensing matrix comprises processing the set of distribution parameters using the first decoder subnet.

In some aspects, the acquisition neural network was trained by: generating a first gradient based on a structural similarity between the first subset of elements of the reconstructed signal tensor and a ground-truth input signal tensor, and updating one or more parameters of the first decoder subnet based on the first gradient.

In some aspects, the reconstruction neural network was trained by: generating a gradient based on an error between the first subset of elements of the reconstructed signal tensor and a ground-truth input signal tensor, and updating one or more parameters of the second decoder subnet and one or more parameters of the second encoder subnet based on the gradient.

At block 620, at least the first subset of elements of the reconstructed signal tensor is output.

In some aspects, the method 600 further includes generating a second subset of elements of the sensing matrix based on processing the second subset of elements of the observed signal tensor and the first subset of elements of the sensing matrix using the acquisition neural network.

### Example Processing System for Reinforcement-Learning-Based Compressed Sensing

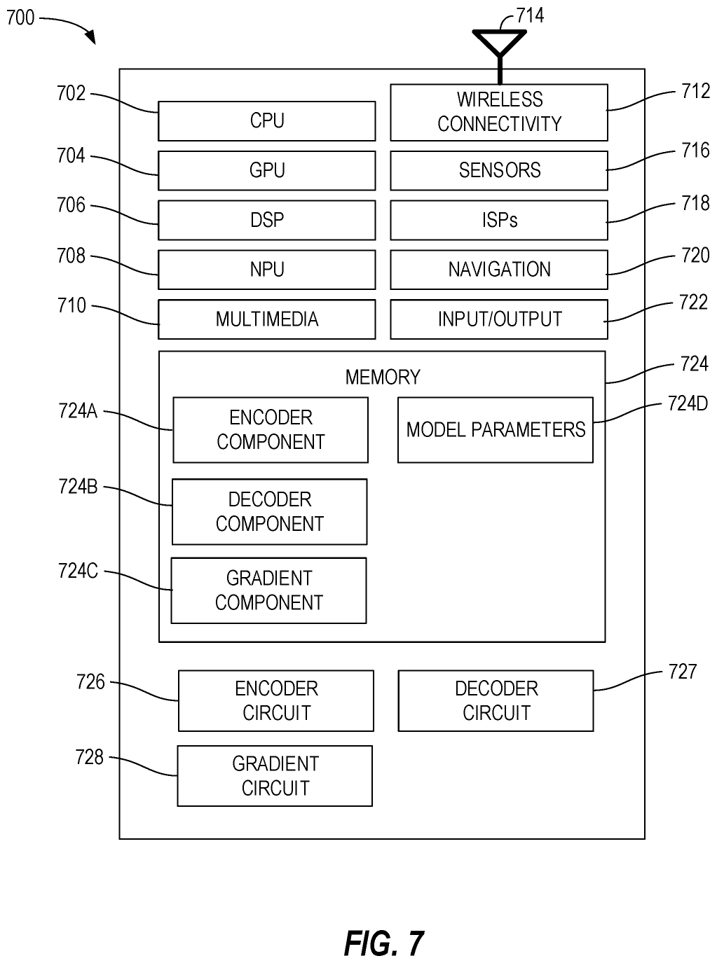

In some aspects, the architectures, workflows, techniques, and methods described with reference to FIGS. 1-6 may be implemented on one or more devices or systems. FIG. 7 depicts an example processing system 700 configured to perform various aspects of the present disclosure, including, for example, the architecture, techniques, and methods described with respect to FIGS. 1-7. In some aspects, the processing system 700 may train, implement, or provide a machine learning model using reinforcement-learning-based architectures, such as the architecture 100 of FIG. 1, the architecture 200 of FIG. 2, and/or the architecture 300 of FIG. 3. Although depicted as a single system for conceptual clarity, in at least some aspects, as discussed above, the operations described below with respect to the processing system 700 may be distributed across any number of devices.

Processing system 700 includes a central processing unit (CPU) 702, which in some examples may be a multi-core CPU. Instructions executed at the CPU 702 may be loaded, for example, from a program memory associated with the CPU 702 or may be loaded from a partition of memory 724.

Processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, NPU 708 is a part of one or more of CPU 702, GPU 704, and/or DSP 706.

In some examples, wireless connectivity component 712 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and other wireless data transmission standards. Wireless connectivity component 712 is further coupled to one or more antennas 714.

Processing system 700 may also include one or more sensor processing units 716 associated with any manner of sensor, one or more image signal processors (ISPs) 718 associated with any manner of image sensor, and/or a navigation component 720, which may include satellite-based positioning system components (e.g., GPS or GLONASS) as well as inertial positioning system components.

Processing system 700 may also include one or more input and/or output devices 722, such as screens, touch-sensitive surfaces (including touch-sensitive displays), physical buttons, speakers, microphones, and the like.

In some examples, one or more of the processors of processing system 700 may be based on an ARM or RISC-V instruction set.

Processing system 700 also includes memory 724, which is representative of one or more static and/or dynamic memories, such as a dynamic random access memory, a flash-based static memory, and the like. In this example, memory 724 includes computer-executable components, which may be executed by one or more of the aforementioned processors of processing system 700.

In particular, in this example, memory 724 includes an encoder component 724A, a decoder component 724B, and a gradient component 724C. Though depicted as discrete components for conceptual clarity in FIG. 7, the illustrated components (and others not depicted) may be collectively or individually implemented in various aspects.

In the illustrated example, the memory 724 further includes model parameters 724D. The model parameters 724D may generally correspond to the learnable or trainable parameters of one or more machine learning models (e.g., encoders 115A, 115B, 215, and/or 315, decoders 125A, 125B, 225A, 225B, 325A, and/or 325B of FIGS. 1, 2, and/or 3) used to generate reconstructed signal tensors for compressed sensing. Though depicted as residing in memory 724 for conceptual clarity, in some aspects, some or all of the model parameters 724D may reside in any other suitable location.

Processing system 700 further comprises encoder circuit 726, decoder circuit 727, and gradient circuit 728. The depicted circuits, and others not depicted, may be configured to perform various aspects of the techniques described herein.

In some aspects, encoder component 724A and encoder circuit 726 may be used to train encoder subnets (during a training phase) and/or to generate distribution parameters and/or latent tensors (during an inferencing phase), as discussed above. Decoder component 724B and decoder circuit 727 may be used to train decoder subnets (during a training phase) and/or to generate reconstructed signal elements and/or sensing matrix elements (during an inferencing phase), as discussed above.

Gradient component 724C and gradient circuit 728 may be used to generate losses and/or gradients to refine the model components (e.g., encoder(s) and decoders) during training, as discussed above. For example, the gradient component 724C and/or gradient circuit 728 may generate acquisition gradients based on the SSIM of the reconstructions, and/or reconstruction gradients based on the MSE of the reconstructions.

Though depicted as separate components and circuits for clarity in FIG. 7, encoder circuit 726, decoder circuit 727, and gradient circuit 728 may collectively or individually be implemented in other processing devices of processing system 700, such as within CPU 702, GPU 704, DSP 706, NPU 708, and the like.

Generally, processing system 700 and/or components thereof may be configured to perform the methods described herein.

Notably, in other aspects, aspects of processing system 700 may be omitted, such as where processing system 700 is a server computer or the like. For example, multimedia processing unit 710, wireless connectivity component 712, sensor processing units 716, ISPs 718, and/or navigation component 720 may be omitted in other aspects. Further, aspects of processing system 700 may be distributed between multiple devices.

### Example Clauses

Implementation examples are described in the following numbered clauses:
Clause 1: A method, comprising: accessing an observed signal tensor comprising a plurality of elements; generating a first subset of elements of a sensing matrix based on processing, from among the plurality of elements, a first subset of elements of the observed signal tensor using an acquisition neural network; generating a first subset of elements of a reconstructed signal tensor based on processing, from among the plurality of elements, a second subset of elements of the observed signal tensor and the first subset of elements of the sensing matrix using a reconstruction neural network; and outputting at least the first subset of elements of the reconstructed signal tensor.
Clause 2: A method according to Clause 1, further comprising generating a second subset of elements of the sensing matrix based on processing the second subset of elements of the observed signal tensor and the first subset of elements of the sensing matrix using the acquisition neural network.
Clause 3: A method according to Clause 1 or 2, wherein: the acquisition neural network comprises a first encoder subnet and a first decoder subnet, and the reconstruction neural network comprises a second encoder subnet and a second decoder subnet.
Clause 4: A method according to Clause 3, wherein the first encoder subnet and the second encoder subnet form a shared encoder subnet.
Clause 5: A method according to Clause 4, wherein generating the first subset of elements of the reconstructed signal tensor comprises: generating a latent tensor based on processing the second subset of elements of the observed signal tensor and the first subset of elements of the sensing matrix using the shared encoder subnet; and generating the first subset of elements of the reconstructed signal tensor based on processing the latent tensor using the second decoder subnet.
Clause 6: A method according to Clause 5, wherein generating the second subset of elements of the sensing matrix comprises processing the latent tensor using the first decoder subnet.
Clause 7: A method according to Clause 4, wherein generating the first subset of elements of the reconstructed signal tensor comprises: generating a set of distribution parameters based on processing the second subset of elements of the observed signal tensor and the first subset of elements of the sensing matrix using the shared encoder subnet; sampling a distribution, defined by the set of distribution parameters, to generate a latent tensor; and generating the first subset of elements of the reconstructed signal tensor based on processing the latent tensor using the second decoder subnet.
Clause 8: A method according to Clause 7, wherein generating the second subset of elements of the sensing matrix comprises processing the set of distribution parameters using the first decoder subnet.
Clause 9: A method according to any of Clauses 3-8, wherein the acquisition neural network was trained by: generating a first gradient based on a structural similarity between the first subset of elements of the reconstructed signal tensor and a ground-truth input signal tensor; and updating one or more parameters of the first decoder subnet based on the first gradient.
Clause 10: A method according to any of Clauses 3-9, wherein the reconstruction neural network was trained by: generating a gradient based on an error between the first subset of elements of the reconstructed signal tensor and a ground-truth input signal tensor; and updating one or more parameters of the second decoder subnet and one or more parameters of the second encoder subnet based on the gradient.
Clause 11: A method according to any of Clauses 1-10, wherein generating the first subset of elements of the sensing matrix comprises: generating a set of distribution parameters by processing the first subset of elements of the observed signal tensor using the acquisition neural network; and sampling a distribution, defined by the set of distribution parameters, to generate the first subset of elements of the sensing matrix.
Clause 12: A method according to any of Clauses 1-11, wherein generating the first subset of elements of the sensing matrix comprises generating an angle parameter by processing the first subset of elements of the observed signal tensor using the acquisition neural network.
Clause 13: method according to any of Clauses 1-12, wherein the first subset of elements of the observed signal tensor and the second subset of elements of the observed signal tensor differ by at least one element.
Clause 14: A processing system comprising: a memory comprising computer-executable instructions; and one or more processors configured to execute the computer-executable instructions and cause the processing system to perform a method in accordance with any of Clauses 1-13.
Clause 15: A processing system comprising means for performing a method in accordance with any of Clauses 1-13.
Clause 16: A non-transitory computer-readable medium comprising computer-executable instructions that, when executed by one or more processors of a processing system, cause the processing system to perform a method in accordance with any of Clauses 1-13.

Clause 17: A computer program product embodied on a computer-readable storage medium comprising code for performing a method in accordance with any of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
accessing an observed signal tensor comprising a plurality of elements;
generating a first subset of elements of a sensing matrix based on processing, from among the plurality of elements, a first subset of elements of the observed signal tensor using an acquisition neural network;
generating a first subset of elements of a reconstructed signal tensor based on processing, from among the plurality of elements, a second subset of elements of the observed signal tensor and the first subset of elements of the sensing matrix using a reconstruction neural network; and
outputting at least the first subset of elements of the reconstructed signal tensor.

2. The computer-implemented method of claim 1, further comprising generating a second subset of elements of the sensing matrix based on processing the second subset of elements of the observed signal tensor and the first subset of elements of the sensing matrix using the acquisition neural network.

3. The computer-implemented method of claim 1, wherein:
the acquisition neural network comprises a first encoder subnet and a first decoder subnet, and
the reconstruction neural network comprises a second encoder subnet and a second decoder subnet.

4. The computer-implemented method of claim 3, wherein the first encoder subnet and the second encoder subnet form a shared encoder subnet.

5. The computer-implemented method of claim 4, wherein generating the first subset of elements of the reconstructed signal tensor comprises:
generating a latent tensor based on processing the second subset of elements of the observed signal tensor and the first subset of elements of the sensing matrix using the shared encoder subnet; and
generating the first subset of elements of the reconstructed signal tensor based on processing the latent tensor using the second decoder subnet.

6. The computer-implemented method of claim 5, wherein generating the second subset of elements of the sensing matrix comprises processing the latent tensor using the first decoder subnet.

7. The computer-implemented method of claim 4, wherein generating the first subset of elements of the reconstructed signal tensor comprises:
generating a set of distribution parameters based on processing the second subset of elements of the observed signal tensor and the first subset of elements of the sensing matrix using the shared encoder subnet;
sampling a distribution, defined by the set of distribution parameters, to generate a latent tensor; and
generating the first subset of elements of the reconstructed signal tensor based on processing the latent tensor using the second decoder subnet.

8. The computer-implemented method of claim 7, wherein generating the second subset of elements of the sensing matrix comprises processing the set of distribution parameters using the first decoder subnet.

9. The computer-implemented method of claim 3, wherein the acquisition neural network was trained by:
generating a gradient based on a structural similarity between the first subset of elements of the reconstructed signal tensor and a ground-truth input signal tensor; and
updating one or more parameters of the first decoder subnet based on the gradient.

10. The computer-implemented method of claim 3, wherein the reconstruction neural network was trained by:
generating a gradient based on an error between the first subset of elements of the reconstructed signal tensor and a ground-truth input signal tensor; and
updating one or more parameters of the second decoder subnet and one or more parameters of the second encoder subnet based on the gradient.

11. The computer-implemented method of claim 1, wherein generating the first subset of elements of the sensing matrix comprises:
generating a set of distribution parameters by processing the first subset of elements of the observed signal tensor using the acquisition neural network; and
sampling a distribution, defined by the set of distribution parameters, to generate the first subset of elements of the sensing matrix.

12. The computer-implemented method of claim 1, wherein generating the first subset of the sensing matrix comprises generating an angle parameter by processing the first subset of the observed signal tensor using the acquisition neural network.

13. The computer-implemented method of claim 1, wherein the first subset of elements of the observed signal tensor and the second subset of elements of the observed signal tensor differ by at least one element.

14. A processing system comprising:
a memory comprising computer-executable instructions; and
one or more processors configured to execute the computer-executable instructions and cause the processing system to perform an operation comprising:
accessing an observed signal tensor comprising a plurality of elements;
generating a first subset of elements of a sensing matrix based on processing, from among the plurality of elements, a first subset of elements of the observed signal tensor using an acquisition neural network;
generating a first subset of elements of a reconstructed signal tensor based on processing, from among the plurality of elements, a second subset of elements of the observed signal tensor and the first subset of elements of the sensing matrix using a reconstruction neural network; and
outputting at least the first subset of elements of the reconstructed signal tensor.

15. The processing system of claim 14, the operation further comprising generating a second subset of elements of the sensing matrix based on processing the second subset of elements of the observed signal tensor and the first subset of elements of the sensing matrix using the acquisition neural network.

16. The processing system of claim 14, wherein:
the acquisition neural network comprises a first encoder subnet and a first decoder subnet, and
the reconstruction neural network comprises a second encoder subnet and a second decoder subnet.

17. The processing system of claim 16, wherein the first encoder subnet and the second encoder subnet form a shared encoder subnet.

18. The processing system of claim 17, wherein generating the first subset of elements of the reconstructed signal tensor comprises:
generating a latent tensor based on processing the second subset of elements of the observed signal tensor and the first subset of elements of the sensing matrix using the shared encoder subnet; and
generating the first subset of elements of the reconstructed signal tensor based on processing the latent tensor using the second decoder subnet.

19. The processing system of claim 18, wherein generating the second subset of elements of the sensing matrix comprises processing the latent tensor using the first decoder subnet.

20. The processing system of claim 17, wherein generating the first subset of elements of the reconstructed signal tensor comprises:
generating a set of distribution parameters based on processing the second subset of elements of the observed signal tensor and the first subset of elements of the sensing matrix using the shared encoder subnet;
sampling a distribution, defined by the set of distribution parameters, to generate a latent tensor; and
generating the first subset of elements of the reconstructed signal tensor based on processing the latent tensor using the second decoder subnet.

21. The processing system of claim 20, wherein generating the second subset of elements of the sensing matrix comprises processing the set of distribution parameters using the first decoder subnet.

22. The processing system of claim 16, wherein the acquisition neural network was trained by:
generating a gradient based on a structural similarity between the first subset of elements of the reconstructed signal tensor and a ground-truth input signal tensor; and
updating one or more parameters of the first decoder subnet based on the gradient.

23. The processing system of claim 16, wherein the reconstruction neural network was trained by:
generating a gradient based on an error between the first subset of elements of the reconstructed signal tensor and a ground-truth input signal tensor; and
updating one or more parameters of the second decoder subnet and one or more parameters of the second encoder subnet based on the gradient.

24. The processing system of claim 14, wherein generating the first subset of elements of the sensing matrix comprises:
generating a set of distribution parameters by processing the first subset of elements of the observed signal tensor using the acquisition neural network; and
sampling a distribution, defined by the set of distribution parameters, to generate the first subset of elements of the sensing matrix.

25. The processing system of claim 14, wherein generating the first subset of elements of the sensing matrix comprises generating an angle parameter by processing the first subset of elements of the observed signal tensor using the acquisition neural network.

26. The processing system of claim 14, wherein the first subset of elements of the observed signal tensor and the second subset of elements of the observed signal tensor differ by at least one element.

27. A non-transitory computer-readable medium comprising computer-executable instructions that, when executed by one or more processors of a processing system, cause the processing system to perform an operation comprising:
accessing an observed signal tensor comprising a plurality of elements;
generating a first subset of elements of a sensing matrix based on processing, from among the plurality of elements, a first subset of elements of the observed signal tensor using an acquisition neural network;
generating a first subset of elements of a reconstructed signal tensor based on processing, from among the plurality of elements, a second subset of elements of the observed signal tensor and the first subset of elements of the sensing matrix using a reconstruction neural network; and
outputting at least the first subset of elements of the reconstructed signal tensor.

28. The non-transitory computer-readable medium of claim 27, the operation further comprising generating a second subset of elements of the sensing matrix based on processing the second subset of elements of the observed signal tensor and the first subset of elements of the sensing matrix using the acquisition neural network.

29. The non-transitory computer-readable medium of claim 27, wherein:
the acquisition neural network comprises a first encoder subnet and a first decoder subnet,
the reconstruction neural network comprises a second encoder subnet and a second decoder subnet, and
the first encoder subnet and the second encoder subnet form a shared encoder subnet.

30. The non-transitory computer-readable medium of claim 29, wherein generating the first subset of elements of the reconstructed signal tensor comprises:
generating a latent tensor based on processing the second subset of elements of the observed signal tensor and the first subset of elements of the sensing matrix using the shared encoder subnet; and
generating the first subset of elements of the reconstructed signal tensor based on processing the latent tensor using the second decoder subnet.

31. The non-transitory computer-readable medium of claim 29, wherein generating the first subset of elements of the reconstructed signal tensor comprises:
generating a set of distribution parameters based on processing the second subset of elements of the observed signal tensor and the first subset of elements of the sensing matrix using the shared encoder subnet;
sampling a distribution, defined by the set of distribution parameters, to generate a latent tensor; and
generating the first subset of elements of the reconstructed signal tensor based on processing the latent tensor using the second decoder subnet.

32. The non-transitory computer-readable medium of claim 27, wherein the first subset of elements of the observed signal tensor and the second subset of elements of the observed signal tensor differ by at least one element.

33. A processing system, comprising:
means for accessing an observed signal tensor comprising a plurality of elements;
means for generating a subset of elements of a sensing matrix based on processing, from among the plurality of elements, a first subset of elements of the observed signal tensor using an acquisition neural network;
means for generating a subset of elements of a reconstructed signal tensor based on processing, from among the plurality of elements, a second subset of elements of the observed signal tensor and the subset of elements of the sensing matrix using a reconstruction neural network; and
means for outputting at least the subset of elements of the reconstructed signal tensor.
